(19) United States
(12) Patent Application Publication
(10) Pub. No.: US 2014/0127576 A1
(43) Pub. Date: May 8, 2014

(54) ACTIVE MATERIAL FOR NONAQUEOUS ELECTROLYTE SECONDARY BATTERIES, METHOD FOR PRODUCING THE SAME, AND NEGATIVE ELECTRODE INCLUDING THE SAME

(71) Applicants: Daisuke Kato, Kyoto (JP); Mai Yokoi, Tokushima (JP); Hiroshi Minami, Hyogo (JP); Naoki Imachi, Hyogo (JP)

(72) Inventors: Daisuke Kato, Kyoto (JP); Mai Yokoi, Tokushima (JP); Hiroshi Minami, Hyogo (JP); Naoki Imachi, Hyogo (JP)

(73) Assignee: SANYO ELECTRIC CO., LTD., Moriguchi-city, Osaka (JP)

(21) Appl. No.: 14/130,564

(22) PCT Filed: Jul. 3, 2012
(86) PCT No.: PCT/JP2012/066959

§ 371 Date: Jan. 2, 2014

(30) Foreign Application Priority Data
Jul. 29, 2011 (JP) 2011-166172
Sep. 27, 2011 (JP) 2011-211013

(51) Int. Cl. H01M 4/36

(52) U.S. Cl. CPC H01M 4/366
USPC 429/213; 427/58

(57) ABSTRACT

The invention provides an active material for nonaqueous electrolyte secondary batteries which contains a silicon oxide as an active material and can suppress the generation of gas during storage at high temperatures, a method for producing such active materials, a negative electrode for nonaqueous electrolyte secondary batteries including the active material, and a nonaqueous electrolyte secondary battery including the negative electrode. An active material for nonaqueous electrolyte secondary batteries is used which includes a silicon oxide having a surface coated with a polyacrylonitrile or a modified product thereof that has been heat treated.

### TECHNICAL FIELD

The present invention relates to active materials for nonaqueous electrolyte secondary batteries, methods for producing the same, negative electrodes including the active materials, and nonaqueous electrolyte secondary batteries including the negative electrodes.

### BACKGROUND ART

In recent years, nonaqueous electrolyte secondary batteries are utilized as power sources in devices such as mobile electronic devices or for applications such as electric power storage. Nonaqueous electrolyte secondary batteries contain a nonaqueous electrolytic solution, and are charged and discharged by the movement of lithium ions between positive and negative electrodes.

In nonaqueous electrolyte secondary batteries, graphite materials are widely used as negative electrode active materials for their negative electrodes.

Graphite materials are advantageous in that the discharge potential is flat, that the occurrence of acicular metallic lithium is suppressed because lithium ions are intercalated into and released from between graphite crystal layers during charging and discharging, and that volume changes by charging and discharging are small.

On the other hand, the recent enhancements in multi-functions and performances of devices such as mobile electronic devices have led to a demand for nonaqueous electrolyte secondary batteries having higher capacity. However, the theoretical capacity of LiC₆ that is a graphite intercalation compound is as low as 372 mAh/g, and thus the above demand is not fully met by graphite materials.

Patent Literature 1 proposes that a silicon oxide capable of storing and releasing lithium ions is used as a negative electrode active material.

Patent Literature 2 proposes that an electron conductive material layer is disposed on the surface of silicon oxide particles.

Patent Literature 3 proposes that a silicon oxide and graphite are mixed with each other to ensure conductivity between particles and to remedy volume expansion, thereby enhancing cycle characteristics.

### CITATION LIST

### Patent Literature

PTL 1: Japanese Published Unexamined Patent Application No. 6-325765
PTL 2: Japanese Published Unexamined Patent Application No. 2002-42806
PTL 3: Japanese Published Unexamined Patent Application No. 2010-212228

### SUMMARY OF INVENTION

### Technical Problem

However, silicon oxides cause a problem that a large amount of gas is generated during storage at high temperatures.

Objects of the present invention are to provide an active material for nonaqueous electrolyte secondary batteries which contains a silicon oxide and can suppress the generation of gas during storage at high temperatures, and to provide a method for producing such active materials, a negative electrode for nonaqueous electrolyte secondary batteries including the active material, and a nonaqueous electrolyte secondary battery including the negative electrode.

### Solution to Problem

An active material for nonaqueous electrolyte secondary batteries according to the present invention includes a silicon oxide having a surface coated with a polyacrylonitrile or a modified product thereof, the polyacrylonitrile or the modified product thereof having been heat treated.

The amount of coating with the polyacrylonitrile or the modified product thereof is preferably in the range of 0.5 to 5 mass % relative to the total mass including the silicon oxide.

A method for producing an active material for nonaqueous electrolyte secondary batteries according to the present invention is a method capable of producing the inventive active material for nonaqueous electrolyte secondary batteries and includes a step of coating the surface of a silicon oxide with a polyacrylonitrile or a modified product thereof, and a step of heat treating the polyacrylonitrile or the modified product thereof covering the surface of the silicon oxide.

The temperature of the heat treatment is preferably in the range of 130 to 400° C.

A negative electrode for nonaqueous electrolyte secondary batteries according to the present invention includes the inventive active material for nonaqueous electrolyte secondary batteries and graphite as negative electrode active materials, and includes a binder.

The binder may include, for example, carboxymethyl cellulose and styrene-butadiene latex.

The content of the active material for nonaqueous electrolyte secondary batteries is preferably in the range of 1 to 100 mass %, and more preferably in the range of 1 to 50 mass % relative to the total mass including the graphite.

A nonaqueous electrolyte secondary battery according to the present invention includes the inventive negative electrode, a positive electrode and a nonaqueous electrolyte.

### Advantageous Effects of Invention

According to the present invention, nonaqueous electrolyte secondary batteries including a silicon oxide as a negative electrode active material can be suppressed from the generation of gas during storage at high temperatures.

### BRIEF DESCRIPTION OF DRAWINGS

FIG. 1 is a schematic view illustrating an active material for nonaqueous electrolyte secondary batteries according to the present invention.

FIG. 2 is a schematic view illustrating a configuration of a silicon oxide and graphite present in a negative electrode for nonaqueous electrolyte secondary batteries according to the present invention.

### DESCRIPTION OF EMBODIMENTS

Any silicon oxide capable of storing and releasing lithium ions may be used. Examples of such silicon oxides include the silicon oxide represented by SiO.

The average particle diameter of the silicon oxide is preferably not less than 1 μm and less than 10 μm. If the average particle diameter is less than 1 μm, the specific surface area of the active material is so increased that the active material may increase the reactivity with nonaqueous electrolytes. On the other hand, a silicon oxide having an average particle diameter of 10 μm or more is easily precipitated in a slurry and can make application difficult at times.

The surface of the silicon oxide is coated with a polyacrylonitrile or a modified product thereof that has been heat treated. As used herein, the term “coated” does not necessarily mean that the entire surface is coated, and may indicate that the surface of the silicon oxide is partially coated. The lower limit of the content of the polyacrylonitrile or the modified product thereof is preferably 0.5 mass % or more, and more preferably 1 mass % or more relative to the total mass including the silicon oxide. The upper limit thereof is preferably 5 mass % or less, and more preferably 3 mass % or less. An excessively small amount of coating may sometimes result in insufficient enhancement in cycle characteristics. An excessively large amount of coating may sometimes cause a decrease in initial charging and discharging efficiency.

The heat treatment is preferably carried out in an inert atmosphere. Examples of the inert atmospheres include vacuum atmosphere and inert gas atmospheres. Examples of the inert gas atmospheres include atmospheres of inert gases such as argon, and atmospheres of other gases such as nitrogen.

The heat treatment temperature is preferably not less than 130° C., more preferably not less than 150° C., and still more preferably not less than 170° C. The upper limit of the heat treatment temperature is preferably 400° C. or less, more preferably 300° C. or less, and still more preferably 250° C. or less. If the temperature of the heat treatment is less than 130° C., the heat treatment may not produce sufficient results. The heat treatment at an excessively high temperature may cause the polyacrylonitrile or the modified product thereof to be carbonized.

For example, the surface of the silicon oxide may be coated with the polyacrylonitrile or the modified product thereof by a method in which the silicon oxide is mixed together with the polyacrylonitrile or the modified product thereof in a solvent in which the polyacrylonitrile or the modified product thereof has been dissolved. In this case, it is preferable that the solid concentration of the silicon oxide and the polyacrylonitrile or the modified product thereof be high. The solid concentration is preferably not less than 50 mass %, more preferably not less than 70 mass %, and still more preferably not less than 85 mass %. The upper limit of the solid concentration is preferably 97 mass % or less, and more preferably 95 mass % or less.

The polyacrylonitrile or the modified product thereof exhibits a small amount of swelling with nonaqueous electrolytes, but this amount of swelling with nonaqueous electrolytes can be further reduced by the heat treatment. Thus, the amount of contact between the silicon oxide and the nonaqueous electrolyte can be controlled more effectively and the occurrence of side reactions with the nonaqueous electrolyte can be suppressed by the coating with the heat-treated polyacrylonitrile or modified product thereof. Probably because of this mechanism, charging and discharging cycle characteristics can be enhanced and the generation of gas during storage at high temperatures can be suppressed.

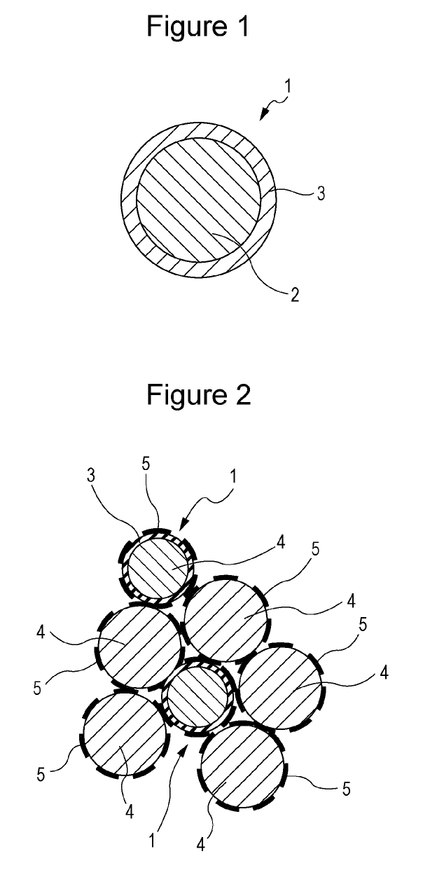

FIG. 1 is a schematic view illustrating an active material for nonaqueous electrolyte secondary batteries. As illustrated in FIG. 1, the active material 1 for nonaqueous electrolyte secondary batteries is composed of a silicon oxide 2 and a heat-treated polyacrylonitrile or modified product thereof 3 covering the surface of the silicon oxide. As mentioned above, the polyacrylonitrile or the modified product thereof 3 may cover only a part of the surface of the silicon oxide 2.

The polyacrylonitrile or the modified product thereof 3 may cover the surface of the silicon oxide 2 directly or indirectly with another substance therebetween. For example, the surface of the silicon oxide 2 may be coated with a carbon material, and the surface of the carbon material may be coated with the polyacrylonitrile or the modified product thereof 3.

A negative electrode for nonaqueous electrolyte secondary batteries includes the inventive active material and graphite as negative electrode active materials, and includes a binder. The lower limit of the content of the active material relative to the total mass of the active material and the graphite is preferably 1 mass % or more, and more preferably 3 mass % or more. The upper limit of the content of the active material relative to the total mass of the active material and the graphite is preferably 20 mass % or less, more preferably 15 mass % or less, and still more preferably 10 mass % or less.

The above content of the active material is advantageous because if the content is excessively small, it may become difficult to obtain effects by the presence of the silicon oxide with high theoretical capacity per unit volume in the negative electrode active material layer.

The active material contains a silicon oxide. The volume of silicon oxides is significantly swollen and shrunk during charging and discharging of nonaqueous electrolyte secondary batteries. When the volume of a silicon oxide is swollen or shrunk, a stress due to the swelling or shrinkage is applied to the boundary between a negative electrode collector and the negative electrode active material layer. The magnitude of this stress is increased with increasing content of the silicon oxide in the negative electrode active material layer. If this stress becomes excessively large, the adhesion between the negative electrode collector and the negative electrode active material layer is decreased. Adding a binder in a large amount is a possible remedy to suppress the decrease in adhesion. However, the addition of a large amount of a binder often requires that the amount of the active material be reduced, causing a decrease in the capacity of nonaqueous electrolyte secondary batteries. Thus, the upper limit of the content of the active material is preferably 20 mass %, more preferably 15 mass %, and still more preferably 10 mass % in order to make sure that the nonaqueous electrolyte secondary battery will satisfy desired electrochemical characteristics while suppressing the decrease in the adhesion of the negative electrode active material layer with respect to the negative electrode collector.

The binder used in the negative electrode preferably includes carboxymethyl cellulose (CMC) and styrene-butadiene latex (SBR). The total CMC content in the negative electrode is preferably 0.7 mass % to 1.5 mass %, and the SBR content is preferably 0.5 mass % to 1.5 mass %.

FIG. 2 is a schematic view illustrating a configuration of the silicon oxide, the graphite and the binder in the negative electrode for nonaqueous electrolyte secondary batteries. The binder 5 is attached to the surface of the mixture of the active material 1 for nonaqueous electrolyte secondary batteries and the graphite 4, thus constituting a negative electrode active material layer in the negative electrode for nonaqueous electrolyte secondary batteries.

A nonaqueous electrolyte secondary battery includes the negative electrode, a positive electrode, and a nonaqueous electrolyte.

The positive electrode active material may be any material without limitation as long as the material can store and release lithium and has a noble potential. Examples include lithium transition metal composite oxides having a layered structure, a spinel structure or an olivine structure. In particular, lithium transition metal composite oxides having a layered structure are preferable from the viewpoint of high energy density. Examples of such lithium transition metal composite oxides include lithium-nickel composite oxide, lithium-nickel-cobalt composite oxide, lithium-nickel-cobalt-aluminum composite oxide, lithium-nickel-cobalt-manganese composite oxide, and lithium-cobalt composite oxide.

Examples of the binders used in the positive electrode include fluororesins having vinylidene fluoride units such as polyvinylidene fluoride (PVdF) and modified PVdF.

Examples of the solvents in the nonaqueous electrolytes include mixed solvents of cyclic carbonates and chain carbonates.

Examples of the cyclic carbonates include ethylene carbonate, fluoroethylene carbonate, propylene carbonate, butylene carbonate, vinylene carbonate and vinyl ethylene carbonate. Examples of the chain carbonates include dimethyl carbonate, methyl ethyl carbonate and diethyl carbonate.

The addition of fluoroethylene carbonate (FEC) to the nonaqueous electrolyte results in the formation of a film on the surface of the silicon oxide active material, thereby suppressing the occurrence of side reactions more effectively. The amount of FEC added is preferably in the range of 1 to 30 mass % in the solvents.

Examples of the solutes in the nonaqueous electrolytes include LiPF₆, LiBF₄, LiCF₃SO₃, LiN(SO₂F)₂, LiN(SO₂CF₃)₂, LiN(SO₂C₂F₅)₂, LiC(SO₂CF₃)₃, LiC(SO₂C₂F₅)₃, LiClO₄, and mixtures thereof.

Further, the electrolyte may be a gel polymer electrolyte which is a polymer such as polyethylene oxide or polyacrylonitrile impregnated with the electrolytic solution.

### Examples

Hereinbelow, the present invention will be described in further detail based on specific examples. However, the scope of the invention is not limited to the following examples. The present invention may be modified appropriately without departing from the scope of the invention.

### Experiment 1

### Example 1

### Coating of Silicon Oxide

Silicon oxide SiO having an average particle diameter of 5.3 μm was used. In N-methyl-2-pyrrolidone (NMP), the silicon oxide and a polyacrylonitrile (PAN) were mixed with each other in a mass ratio (SiO:PAN) of 97:3. The solid concentration of SiO and PAN in NMP was 75 mass %.

After mixing by stirring, the NMP solvent was filtered. In this manner, the surface of the silicon oxide was coated with PAN.

Next, the PAN-coated silicon oxide was heat treated at 190° C. in a vacuum atmosphere for 10 hours. Thus, the PAN covering the surface of the silicon oxide was crosslinked.

### [Fabrication of Negative Electrode]

The PAN-coated silicon oxide active material and graphite were mixed with each other in a mass ratio (graphite:silicon oxide active material) of 96:4. The resultant mixture was used as a negative electrode active material. The negative electrode active material was mixed together with carboxymethyl cellulose (CMC) and styrene-butadiene latex (SBR) in a mass ratio (negative electrode active material:CMC:SBR) of 97.5:1:1.5 in water to give a negative electrode mixture slurry.

The negative electrode mixture slurry was applied to both sides of a copper foil. After the mixture slurry was dried at 105° C. in air, the assembly was rolled to form a negative electrode. The bulk density of the negative electrode mixture layer was 1.60 g/cm³.

### [Fabrication of Positive Electrode]

Lithium cobaltate was used as a positive electrode active material, acetylene black as a carbon conductive agent, and polyvinylidene fluoride (PVdF) as a binder. In an NMP solvent, these were mixed together in a mass ratio (lithium cobaltate:acetylene black:PVdF) of 95:2.5:2.5 to give a positive electrode mixture slurry. COMBI MIX manufactured by PRIMIX Corporation was used as the mixer.

The obtained positive electrode mixture slurry was applied to both sides of an aluminum foil. After drying, the assembly was rolled to form a positive electrode. The bulk density of the positive electrode mixture layer was 3.6 g/cm³.

### [Preparation of Nonaqueous Electrolytic Solution]

Ethylene carbonate (EC), fluoroethylene carbonate (FEC) and methyl ethyl carbonate (MEC) were mixed together in a volume ratio (EC:FEC:MEC) of 29:1:70 to give a mixed solvent. In this mixed solvent, lithium phosphate hexafluoride (LiPF₆) was dissolved in 1.0 mol/L. A nonaqueous electrolytic solution was thus prepared.

### [Fabrication of Lithium Ion Secondary Battery]

The positive electrode and the negative electrode were arranged opposed to each other via a polyethylene separator, and the layers were wound into a spiral electrode unit. The positive electrode tab and the negative electrode tab were arranged to be at the outermost periphery of the respective electrodes. The spiral electrode unit was pressed into a flat electrode unit.

The electrode unit was placed into an aluminum laminate battery exterior case. After drying was performed at 105° C. in vacuum for 2 hours, the nonaqueous electrolytic solution was poured, and the case was sealed. A lithium secondary battery for testing was thus fabricated. The designed capacity of the battery was 800 mAh.

### Example 2

A battery for testing was fabricated in the same manner as in EXAMPLE 1, except that the silicon oxide and PAN were mixed together in a mass ratio (SiO:PAN) of 98:2 and the mixture was used as the negative electrode active material.

### Example 3

A battery for testing was fabricated in the same manner as in EXAMPLE 1, except that the silicon oxide and PAN were mixed together in a mass ratio (SiO:PAN) of 99:1 and the mixture was used as the negative electrode active material.

### Example 4

A silicon oxide active material was prepared in the same manner as in EXAMPLE 1, except that the silicon oxide and PAN were mixed together by stirring in NMP such that the solid concentration would be 90 mass %. A battery for testing was fabricated using this silicon oxide active material in the same manner as in EXAMPLE 1.

### Comparative Example 1

A negative electrode was fabricated in the same manner as in EXAMPLE 1, except that the silicon oxide was used as the silicon oxide active material directly without being coated with PAN. A battery for testing was fabricated using this negative electrode.

### Comparative Example 2

A negative electrode was fabricated in the same manner as in EXAMPLE 1, except that the PAN-coated silicon oxide was used as the silicon oxide active material without being subjected to the heat treatment. A battery for testing was fabricated using this negative electrode.

### [Evaluation of Battery Performance]

The batteries for testing were charged and discharged under the following charging and discharging conditions to determine the initial charging and discharging efficiency and the capacity retention after 300 cycles with respect to each of the test batteries.

Charging Conditions

The batteries were charged at a constant current of 1 lt (800 mA) to 4.2 V, and were charged at a constant voltage of 4.2 V until the current reached 1/20 lt (40 mA).

Discharging Conditions

The batteries were discharged at a constant current of 1 lt (800 mA) until the voltage became 2.75 V.

Intervals

The intervals between the charging and the discharging were 10 minutes.

The initial charging and discharging efficiency and the capacity retention after 300 cycles were determined as follows.

Initial charging and discharging efficiency (%)=[(discharge capacity in 1st cycle)/(charge capacity in 1st cycle)]×100

Capacity retention after 300 cycles (%)=[(discharge capacity in 300th cycle)/(discharge capacity in 1st cycle)]×100

Further, a storage test at 60° C. was carried out in the following manner.

After the first cycle of charging and discharging, the battery was recharged to 4.2 V and was stored in an atmosphere at 60° C. for 20 days. The thickness of the battery was measured before and after the storage. The difference between the thicknesses was obtained as the “amount of swelling (mm) during 60° C. storage”. Based on the increase, gas generation during high temperature storage was evaluated.

Table 1 describes the amounts (mass %) of PAN coating in the silicon oxide active materials in the negative electrodes, the initial charging and discharging efficiencies, the capacity retentions after 300 cycles, and the amounts of swelling during 60° C. storage obtained in EXAMPLES 1 to 4 and COMPARATIVE EXAMPLES 1 and 2.

TABLE 1

| | | | | Amount of |
|---|---|---|---|---|
| | Amount of | Initial | Capacity | swelling |
| | PAN | charging and | retention | during 60° C. |
| | coating | discharging | after 300 | storage |
| | (%) | efficiency (%) | cycles (%) | (mm) |
| EX. 1 | 3 | 88.6 | 79.2 | 0.831 |
| EX. 2 | 2 | 88.8 | 77.9 | 0.814 |
| EX. 3 | 1 | 89.0 | 76.0 | 0.917 |
| EX. 4 | 3 | 88.4 | 82.1 | 0.698 |
| COMP. EX. 1 | 0 | 87.9 | 74.0 | 1.259 |
| COMP. EX. 2 | 3 | 87.7 | 72.1 | 1.299 |

As described in Table 1, EXAMPLES 1 to 4 resulted in markedly small amounts of swelling during 60° C. storage compared to COMPARATIVE EXAMPLES 1 and 2, probably because the reaction between the silicon oxide and the electrolytic solution was successfully suppressed by the coating of the silicon oxide surface with the heat-treated PAN and thereby the amounts of gas generated during high temperature storage were significantly decreased.

EXAMPLES 1 to 4 achieved a marked improvement in capacity retention after 300 cycles as compared to COMPARATIVE EXAMPLES 1 and 2. Further, the comparison of EXAMPLES 1 to 3 illustrates that the improvement in the capacity retention after 300 cycles is greater with increasing amount of PAN added. This tendency probably indicates that the reaction with the electrolytic solution is suppressed more effectively in proportion to the amount of coating on the surface of the silicon oxide particles.

From the comparison between EXAMPLE 1 and EXAMPLE 4, the capacity retention after 300 cycles was higher and the amount of swelling during 60° C. storage was smaller in EXAMPLE 4. These results are probably because the effects in the suppression of gas generation and in the improvements in cycle characteristics are obtained more easily by increasing the solid concentration in carrying out the coating treatment for the silicon oxide surface with PAN. The reason for this is probably that because the solvent and the PAN compete with each other to adsorb to the surface of the silicon oxide particles, the PAN present in a higher concentration has a more chance to become adsorbed to the surface of the silicon oxide particles.

From the comparison of EXAMPLES 1 to 4 with COMPARATIVE EXAMPLES 1 and 2, the initial charging and discharging efficiency was improved in EXAMPLES 1 to 4. This result too is considered to be because the reaction between the silicon oxide and the electrolytic solution at the early cycle was successfully suppressed by the coating of the surface of the silicon oxide particles with the heat-treated PAN.

The comparison of EXAMPLE 1 with COMPARATIVE EXAMPLE 2 clearly shows that it is necessary that the PAN covering the surface of the silicon oxide particles have been heat-treated. The reason for this is probably because the heat treatment allows the amount of swelling with electrolytic solutions to be sufficiently controlled and the reactivity with electrolytic solutions to be suppressed.

### Experiment 2

### Example 5

A negative electrode was fabricated in the same manner as in EXAMPLE 1, except that the PAN-coated silicon oxide active material and the graphite were mixed with each other in a mass ratio (graphite:silicon oxide active material) of 99:1.

### [Fabrication of Lithium Ion Secondary Battery]

A lithium metal foil as a counter electrode and the negative electrode were arranged opposed to each other via a polyethylene separator, and the layers were wound into a spiral electrode unit. The counter electrode tab and the negative electrode tab were arranged to be at the outermost periphery of the respective electrodes.

The electrode unit was placed into an aluminum laminate battery exterior case. The nonaqueous electrolytic solution was poured, and the case was sealed. A lithium secondary battery for testing was thus fabricated. The designed capacity of the battery was 70 mAh.

### Example 6

A battery for testing was fabricated in the same manner as in EXAMPLE 5, except that the negative electrode was made by mixing the PAN-coated silicon oxide and the graphite with each other in a mass ratio (graphite:silicon oxide active material) of 96:4.

### Example 7

A battery for testing was fabricated in the same manner as in EXAMPLE 5, except that the negative electrode was made by mixing the PAN-coated silicon oxide and the graphite with each other in a mass ratio (graphite:silicon oxide active material) of 90:10.

### Example 8

A battery for testing was fabricated in the same manner as in EXAMPLE 5, except that the negative electrode was made by mixing the PAN-coated silicon oxide and the graphite with each other in a mass ratio (graphite:silicon oxide active material) of 80:20.

### Example 9

A battery for testing was fabricated in the same manner as in EXAMPLE 5, except that the negative electrode was made by mixing the PAN-coated silicon oxide and the graphite with each other in a mass ratio (graphite:silicon oxide active material) of 50:50.

### Example 10

A battery for testing was fabricated in the same manner as in EXAMPLE 5, except that the negative electrode was made by mixing the PAN-coated silicon oxide and the graphite with each other in a mass ratio (graphite:silicon oxide active material) of 0:100.

### Comparative Example 3

A battery for testing was fabricated in the same manner as in EXAMPLE 5, except that the silicon oxide was used as the silicon oxide active material directly without being coated with PAN.

### Comparative Example 4

A battery for testing was fabricated in the same manner as in EXAMPLE 6, except that the silicon oxide was used as the silicon oxide active material directly without being coated with PAN.

### Comparative Example 5

A battery for testing was fabricated in the same manner as in EXAMPLE 7, except that the silicon oxide was used as the silicon oxide active material directly without being coated with PAN.

### Comparative Example 6

A battery for testing was fabricated in the same manner as in EXAMPLE 8, except that the silicon oxide was used as the silicon oxide active material directly without being coated with PAN.

### Comparative Example 7

A battery for testing was fabricated in the same manner as in EXAMPLE 9, except that the silicon oxide was used as the silicon oxide active material directly without being coated with PAN.

### Comparative Example 8

A battery for testing was fabricated in the same manner as in EXAMPLE 10, except that the silicon oxide was used as the silicon oxide active material directly without being coated with PAN.

### [Evaluation of Battery Performance]

The batteries for testing were charged and discharged under the following charging and discharging conditions to determine the initial charging and discharging efficiency and the capacity retention after 10 cycles with respect to each of the test batteries.

Charging Conditions

The batteries were charged at a constant current of 0.1 lt (7 mA) to 0 V.

Discharging Conditions

The batteries were discharged at a constant current of 0.1 lt (7 mA) until the voltage became 1 V.

Intervals

The intervals between the charging and the discharging were 10 minutes.

The initial charging and discharging efficiency and the capacity retention after 10 cycles were determined as follows.

Initial charging and discharging efficiency (%)=[(discharge capacity in 1st cycle)/(charge capacity in 1st cycle)]×100

Capacity retention after 10 cycles (%)=[(discharge capacity in 10th cycle)/(discharge capacity in 1st cycle)]×100

Table 2 describes the amounts (mass %) of PAN coating in the silicon oxide active materials in the negative electrodes, the initial charging and discharging efficiencies, and the capacity retentions after 10 cycles obtained in EXAMPLES 5 to 10 and COMPARATIVE EXAMPLES 3 to 8.

| | Amount | Content of | Initial | Capacity |
|---|---|---|---|---|
| | of PAN | silicon oxide | charging and | retention |
| | coating | active | discharging | after 10 |
| | (%) | material (%) | efficiency (%) | cycles (%) |
| EX. 5 | 3 | 1 | 93.8 | 99.3 |
| EX. 6 | 3 | 4 | 90.5 | 97.5 |
| EX. 7 | 3 | 10 | 85.9 | 92.5 |
| EX. 8 | 3 | 20 | 81.1 | 86.1 |
| EX. 9 | 3 | 50 | 74.9 | 83.9 |
| EX. 10 | 3 | 100 | 67.3 | 64.5 |
| COMP. EX. 3 | 0 | 1 | 92.6 | 98.7 |
| COMP. EX. 4 | 0 | 4 | 87.6 | 95.8 |
| COMP. EX. 5 | 0 | 10 | 82.1 | 88.0 |
| COMP. EX. 6 | 0 | 20 | 78.1 | 73.6 |
| COMP. EX. 7 | 0 | 50 | 72.1 | 45.8 |
| COMP. EX. 8 | 0 | 100 | 63.5 | 26.7 |

As clear from the results in Table 2, the initial charging and discharging efficiency was decreased with increasing content of the silicon oxide active material. However, it has been illustrated that the capacity retention after cycles was improved in EXAMPLES 5 to 10 involving the PAN-coated silicon oxide active material compared to COMPARATIVE EXAMPLES 3 to 8 in which the silicon oxide active material was not coated with PAN.

From the results in Table 2, it has been demonstrated that the content of the silicon oxide active material in the invention is preferably in the range of 1 to 100 mass %, and more preferably in the range of 1 to 50 mass % relative to the total mass including the graphite.

### Reference Experiment

### Reference Example 1

The polyacrylonitrile (PAN) used in EXAMPLES was formed into a sheet, which was dried at room temperature and cut to a 2 cm×5 cm size. The sheet which was cut was dried in a vacuum atmosphere at 105° C. for 2 hours, and the weight was measured.

Thereafter, the sheet was soaked in the electrolytic solution at 60° C. for 2 days. After the soaking, the sheet was removed from the electrolytic solution and the mass thereof was measured. The impregnation rate was determined by the following equation. The result is described in Table 3.

Impregnation rate (%)=(mass after soaking−mass after drying)/mass after soaking

### Reference Example 2

The impregnation rate was measured in the same manner as in REFERENCE EXAMPLE 1, except that the drying at 105° C. for 2 hours was replaced by heat treatment in a vacuum atmosphere at 150° C. for 10 hours.

### Reference Example 3

The impregnation rate was measured in the same manner as in REFERENCE EXAMPLE 1, except that the drying at 105° C. for 2 hours was replaced by heat treatment in a vacuum atmosphere at 190° C. for 10 hours.

The measurement results are described in Table 3.

TABLE 3

| | Heat treatment | Impregnation |
|---|---|---|
| | temperature | rate |
| REF. EX. 1 | — | 15.8% |
| REF. EX. 2 | 150° C. | 1.4% |
| REF. EX. 3 | 190° C. | 0.7% |

As clear from the results in Table 3, the impregnation rate is decreased by heat treating the polyacrylonitrile. Accordingly, it is most likely that the liquid absorbing tendency, namely, the amount of swelling with electrolytic solutions, of the polyacrylonitrile covering the silicon oxide will be similarly reduced by heat treatment. Thus, it is considered that a contact between the silicon oxide and the nonaqueous electrolytic solution is limited by heat treating the polyacrylonitrile in accordance with the invention, and consequently side reactions between the nonaqueous electrolytic solution and the negative electrode active material are suppressed.

The heat treatment probably removes CN groups from the polyacrylonitriles and modified products thereof. It is probably because of this CN removal that the rate of impregnation with nonaqueous electrolytic solutions is decreased.

### REFERENCE SIGNS LIST

1 . . . ACTIVE MATERIAL FOR NONAQUEOUS ELECTROLYTE SECONDARY BATTERIES
2 . . . SILICON OXIDE
3 . . . HEAT-TREATED POLYACRYLONITRILE OR MODIFIED PRODUCT THEREOF
4 . . . GRAPHITE
5 . . . BINDER

1. An active material for nonaqueous electrolyte secondary batteries comprising a silicon oxide having a surface coated with a polyacrylonitrile or a modified product thereof, the polyacrylonitrile or the modified product thereof having been heat treated.

2. The active material for nonaqueous electrolyte secondary batteries according to claim 1, wherein the amount of coating with the polyacrylonitrile or the modified product thereof is in the range of 0.5 to 5.0 mass % relative to the total mass including the silicon oxide.

3. A method for producing the active material for nonaqueous electrolyte secondary batteries described in claim 1, comprising:
a step of coating the surface of the silicon oxide with the polyacrylonitrile or the modified product thereof; and
a step of heat treating the polyacrylonitrile or the modified product thereof covering the surface of the silicon oxide.

4. The method for producing the active material for nonaqueous electrolyte secondary batteries according to claim 3, wherein the temperature of the heat treatment is in the range of 130 to 400° C.

5. A negative electrode for nonaqueous electrolyte secondary batteries, comprising the active material for nonaqueous electrolyte secondary batteries described in claim 1 and graphite as negative electrode active materials; and a binder.

6. The negative electrode for nonaqueous electrolyte secondary batteries according to claim 5, wherein the binder includes carboxymethyl cellulose and styrene-butadiene latex.

7. The negative electrode for nonaqueous electrolyte secondary batteries according to claim 5, wherein the content of the active material for nonaqueous electrolyte secondary batteries is in the range of 1 to 100 mass % relative to the total mass including the graphite.

8. The negative electrode for nonaqueous electrolyte secondary batteries according to claim 5, wherein the content of the active material for nonaqueous electrolyte secondary batteries is in the range of 1 to 50 mass % relative to the total mass including the graphite.

9. A nonaqueous electrolyte secondary battery comprising the negative electrode described in claim 5, a positive electrode and a nonaqueous electrolyte.
